(19) United States
(12) Patent Application Publication
(10) Pub. No.: US 2005/0286990 A1
(43) Pub. Date: Dec. 29, 2005

(54) Tightening system for secure connection of at least two elements with one another

(76) Inventor: Peter Koppenhoefer, Portland, PA (US)

Correspondence Address: Striker, Striker & Stenby, 103 East Neck Road, Huntington, NY, 11743, US

(21) Appl. No.: 10/875,633

(22) Filed: Jun. 24, 2004

(51) Int. Cl. F16B 39/02

(52) U.S. Cl. 411/432

(57) ABSTRACT

A tightening system for secure connection of at least two elements with one another has a connecting member extending in line openings provided in the elements and having two opposite ends with at least one of the ends adapted to extend outwardly beyond at least one of the elements, a spacer member arranged rotatably between the elements, holding means arranged as the other end of the connecting member, and a tightening member arranged on the at least one end of the connecting member, the spacer member being freely rotatable on the connecting member to prevent cutting of the member.

### BACKGROUND OF THE INVENTION

The present invention relates to a device for secure tightening of two elements with one another.

In the oil and gas field a theft of wellheads and other valves presents a problem. It is therefore advisable to find means for preventing easy removal of the flange bolts with hammer wrenches, pipe wrenches, etc.

### SUMMARY OF THE INVENTION

Accordingly, it is an object of the present invention to provide a tightening system for secure connection of at least two elements with one another which avoids the disadvantages of the prior art.

More particularly, it is an object of the present invention to provide a tightening system for secure connection of at least two elements with one another which prevents easy removal of the flange bolts with hammer wrenches, pipe wrenches, etc.

In keeping with these objects and with others which will become apparent hereinafter, one feature of the present invention resides, briefly stated, in a tightening system for secure connection of at least two elements with one another, comprising a connecting member extending in line openings provided in the elements and having two opposite ends with at least one of the ends adapted to extend outwardly beyond at least one of the elements, a spacer member arranged rotatably between the elements, holding means arranged at the other end of the connecting member, and a tightening member arranged on the at least one end of the connecting member, the spacer member being freely rotatable on the connecting member to prevent cutting of the member.

When the device is designed in accordance with the present invention, it prevents easy removal of the flange bolt.

In accordance with other features of the present invention the holding means can include a holding member arranged on the other end of the connecting member and formed to prevent the use of a pipe wrench, and the tightening member can have a part formed to be freely rotatable on the one end of the connecting member also to prevent the application of a pipe wrench.

In accordance with another feature of the present invention the rotatable spacing member is formed as a hardened spacer.

In accordance with still another feature of the present invention, the holding member is formed as a tapered nut which is non suitable for use of a pipe wrench for loosening.

In accordance with a further feature of the present invention, a lock washer is arranged between the tapered nut and a respective one of the elements.

In accordance with still a further feature of the present invention, the tightening member includes a nut threaded on said other clamp of said connecting member, and a sleeve surrounding the nut and turnable relative to said nut.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a device for secure tightening of two elements, for example flanges, with one another, in accordance with the present invention;

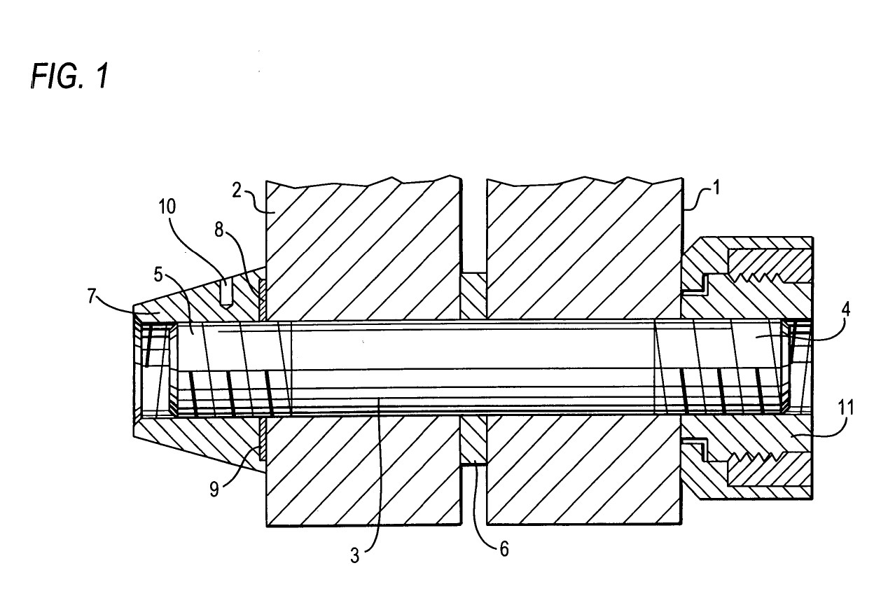

FIG. 2 is a view showing an installation of a security nut of the device in accordance with the present invention;

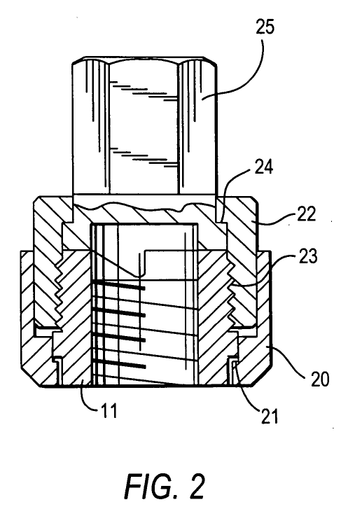

FIG. 3 is a perspective view of the security nut of the device in accordance with the present invention; and

FIG. 4 is a view schematically showing the device in accordance with a further embodiment of the invention.

### DESCRIPTION OF THE PREFERRED EMBODIMENTS

A device in accordance with the present invention is used for secure tightening of two elements, such as for example two flanges 1 and 2. The device includes a connecting member or a stud which is identified with reference numeral 3. The connecting member 3 has a first threaded end 4 extending outwardly beyond the flange 1 and a second threaded end 5 extending outwardly beyond the flange 2.

In accordance with the present invention, a member 6 is arranged between the flanges 1 and 2. The member 6 can be formed as a hardened steel spacer which is fitted to a space between the flanges 1 and 2 and is rotatable on the connecting member 3. Therefore, cutting off of the connecting member 3 with a reciprocating saw or hacksaw is prevented. The member 6 can thereby prevent the destruction of the device and removal of the connecting member 3 by cutting in the space between the flanges 1 and 2.

A back nut 7 is screwed on the threaded end 5 of the connecting member 3. It is tapered to prevent the use of a pipe wrench for loosening. The back nut 7 has a recess or a space 8 in which a lock washer 9 is provided. The lock washer 9 can be formed as a conventional lock washer having teeth which slightly engage into the left side of the flange 2 upon tightening. The back nut 7 also has a small hole 10 for a tommy bar/pin, to stabilize the back nut 7 during the assembly process.

For tightening the device a security nut 11 is utilized. The nut 11 has an outer thread 12, an inner thread 13, and axially extending teeth 14 which are circumferentially spaced from one another and form a crown. Each of the teeth 14 can have a front flank 15 which extends substantially in an axial direction, and a back flank 15 which is inclined in a circumferential direction of each tooth.

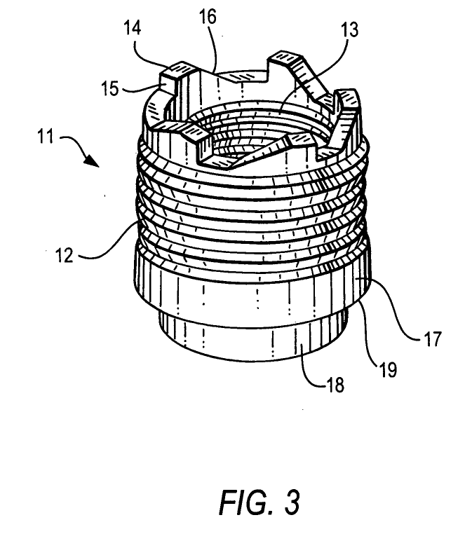

A lower end of the nut 11 shown in FIG. 3 has a shoulder 19 formed between a larger diameter portion 17 and a smaller diameter portion 18.

A sleeve 20 is arranged on the nut 11 and has a shoulder 21 cooperating with the shoulder 19 of the nut. The sleeve 20 can be formed as an armored sleeve and is arranged freely rotatably on the nut 11 after tightening of the nut. Since the sleeve is free to rotate after the nut has been tightened, it prevents the application of a pipe wrench to the nut.

While the inner thread 13 of the nut 11 cooperates with the outer thread of the end 4 of the connecting member 3, the outer thread 12 of the nut 11 cooperates with an inner thread 23 of the retaining sleeve 22. The retaining sleeve 22 has a shoulder identified with a reference numeral 24.

The device further has a nut drive which is identified with reference numeral 25. The nut drive which is formed as a crown drive bit engages the crown of the nut 11 and is kept connected to the nut by the sleeve 22.

For tightening of the nut the retaining sleeve 12, with the portion of the nut driver 25 inside, is screwed onto the nut 11 until the crown of the nut drive 25 engages with the crown of the nut 11. When the nut drive 25 is turned, the rotational force is applied against the front, square flank 15 of the teeth and the nut 11 is tightened. Then the retaining sleeve 12 is unscrewed from the nut 11 and removed together with the nut drive 25. For loosening of the nut, the retaining sleeve 12, with the portion of the nut drive 25 inside, is screwed onto the nut 11 until the crown of the nut drive 25 engages with the crown of the nut 11 and the nut drive 25 is turned in an opposite direction. The rotational force applied against the back angled flank 16 of the teeth, and the nut 11 is unscrewed.

The crown shape of the nut prevents the use of a chisel to loosen the nut. The chisel would glance off the angle of the back flank of the teeth preventing the nut from being loosened.

A common torque tool, manual, air or hydraulically operated, can be applied to the device for tightening or loosening, abutting against the flange or adjacent nut for reaction.

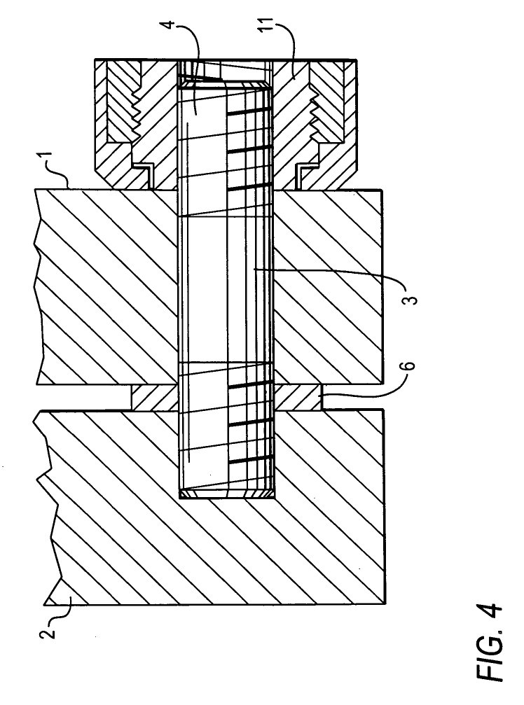

FIG. 4 shows another embodiment of the present invention, which is substantially similar to the above mentioned first embodiment. In contrast to the first embodiment, in the embodiment shown in FIG. 4, the connecting member which is identified with reference numeral 3′ does not extend beyond both ends of the two flanges 1 and 2. In contrast, the connecting member 3′ extends completely through the flange member 1 and is screwed into a blind hole of the flange member 2, to form the holding means. In this embodiment, the member 6 formed as a hardened steel spacer and also the security nut 11 can be the same as in the first embodiment.

It will be understood that each of the elements described above, or two or more together, may also find a useful application in other types of constructions differing from the types described above.

While the invention has been illustrated and described as embodied in a tightening system for secure connection of at least two elements with one another, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A tightening system for secure connection of at least two elements with one another, comprising a connecting member extending in line openings provided in the elements and having two opposite ends with at least one of said ends adapted to extend outwardly beyond at least one of the elements, holding means arranged as the other end of said connecting member, and a tightening member arranged on said at least one end of said connecting member, and means for preventing cutting of said member and including a spacer member which is freely rotatable on said connecting member between the elements.

2. A tightening system as defined in claim 1, wherein said rotatable spacer member is formed as a hardened spacer.

3. A tightening system as defined in claim 1, wherein said other end extends outwardly beyond the other of the elements, said holding means including a holding member mounted on the other end of said connecting member.

4. A tightening system as defined in claim 3, wherein said holding member having a shape such as to prevent use of a pipe wrench for loosening.

5. (canceled)

6. A tightening system as defined in claim 11; and further comprising a lock washer arranged between said tapered nut and a respective one of the elements.

7. A tightening system as defined in claim 1, wherein said tightening member has an outer part which is freely rotatable relative to said connecting member to prevent use of a pipe wrench for loosening.

8. A tightening system as defined in claim 7, wherein said tightening member includes a nut threaded on said other end of said connecting member, said outer part being formed as a sleeve surrounding said nut and turnable relative to said nut and said connecting member.

9-10. (canceled)

11. A tightening system for secure connection of at least two elements with one another, comprising a connecting member extending in line openings provided in the elements and having two opposite ends with at least one of said ends adapted to extend outwardly beyond at least one of the elements, holding means arranged as the other end of said connecting member, and a tightening member arranged on said at least one end of said connecting member, and means for preventing cutting of said member and including a spacer member which is freely rotatable on said connecting member between the elements, said holding means including a holding member which is mounted on the other end of said connecting member and is formed as a tapered nut with an outwardly exposed unobstructed tapered surface which is not suitable for use of a pipe wrench for loosening.

12. A tightening system for secure connection of at least two elements with one another, comprising a connecting member extending in line openings provided in the elements and having two opposite ends with at least one of said ends adapted to extend outwardly beyond at least one of the elements, holding means arranged as the other end of said connecting member, and a tightening member arranged on said at least one end of said connecting member, and means for preventing cutting of said member and including a space member which is freely rotatable on said connecting member between the elements, said tightening member having a crown nut with an inner circumferential surface provided with a thread cooperating with a thread of said threaded member, an outer circumferential surface provided with an outer thread, and an end surface provided with a crown including a plurality of teeth each having a substantially axially extending front flank and a peripherally inclined rear flank, said tightening member further having a retaining sleeve having an inner circumferential surface provided with a thread cooperating with said outer thread of said nut and a radially inwardly extending shoulder so that when a driver provided with a crown engages said crown of said nut said retaining sleeve retains said driver against axial displacement and disengagement from said nut, said tightening member further having an outer part which radially outwardly surrounds said nut and said retaining sleeve and is freely rotatable relative to said connecting member to prevent use of a pipe wrench for loosening.
